(19) United States
(12) Patent Application Publication
(10) Pub. No.: US 2014/0307601 A1
(43) Pub. Date: Oct. 16, 2014

(54) POWER SAVING ENHANCEMENTS WITH LOW LATENCY 802.11

(71) Applicant: QUALCOMM INCORPORATED, San Diego, CA (US)

(72) Inventors: Prerepa Viswanadham, Fremont, CA (US); Kevin N. Hayes, Mountain View, CA (US)

(73) Assignee: QUALCOMM INCORPORATED, San Diego, CA (US)

(21) Appl. No.: 13/864,165

(22) Filed: Apr. 16, 2013

(51) Int. Cl. H04W 52/02

(52) U.S. Cl. CPC H04W 52/0225
USPC 370/311

(57) ABSTRACT

An access terminal transmits at least one uplink transaction to an access point during a transaction slot of a frame including a plurality of slots, when a transaction criterion is satisfied. The transaction criterion may be receipt of a beacon signal from the access point indicating the access point has downlink data for the access terminal. In this case, the uplink transaction includes a trigger configured to pull downlink data from the access point. The access terminal may transmit a burst of uplink transactions over a number of frames, until it receives an empty indication from the access point indicating that all available downlink data has been pulled from the access point. The transaction criterion may be a presence of uplink data at the access point that is intended for the access point. In this case, the access terminal transmits data for the access point during the uplink transaction.

### BACKGROUND

1. Field

The present disclosure relates generally to communication systems, and more particularly, to power saving during access terminal communication with access points in wireless networks.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include IEEE 802.11 (Wi-Fi), IEEE 802.16 (WiMAX), IEEE 802.20, code division multiple access (CDMA) systems, time division multiple access (TDMA) systems, frequency division multiple access (FDMA) systems, orthogonal frequency division multiple access (OFDMA) systems such as Flash-OFDMA, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. However, as the demand for mobile broadband access continues to increase, there exists a need for further improvements in the underlying technology. Preferably, these improvements should be applicable to various multi-access technologies and the telecommunication standards that employ these technologies.

### SUMMARY

In an aspect of the disclosure, a method, a computer program product, and an apparatus are provided. An access terminal transmits at least one uplink transaction to an access point during a transaction slot of a frame including a plurality of slots, when a transaction criterion is satisfied. The transaction criterion may be receipt of a beacon signal from the access point indicating the access point has downlink data for the access terminal. In this case, the uplink transaction includes a trigger configured to pull downlink data from the access point. The access terminal may transmit a burst of uplink transactions over a number of frames, until it receives an empty indication from the access point indicating that all available downlink data has been pulled from the access point. The transaction criterion may be a presence of uplink data at the access point that is intended for the access point. In this case, the access terminal transmits data for the access point during the uplink transaction.

### BRIEF DESCRIPTION OF THE DRAWINGS

These and other aspects of the disclosure will be described in the detailed description, in the appended claims that follow, and in the accompanying drawings, wherein:

FIG. 1 is a diagram illustrating a wireless access network.

FIG. 2 is a timing diagram illustrating a conventional mode of access terminal communication with an access point.

FIG. 3 is a timing diagram illustrating an enhanced mode of access terminal communication with an access point.

FIG. 4 is a block diagram illustrating an access point in communication with an access terminal in an access network.

FIG. 5 is a flow chart of a method of wireless communication by an access terminal.

FIG. 6 is a conceptual data flow diagram illustrating the data flow between different modules/means/components in an exemplary apparatus.

FIG. 7 is a diagram illustrating an example of a hardware implementation for an apparatus employing a processing system

In accordance with common practice the various features illustrated in the drawings may be simplified for clarity. Thus, the drawings may not depict all of the components of a given apparatus (e.g., device) or method. In addition, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein, may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA), TDMA, OFDMA systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (AP) may comprise, be implemented as, or known as a Node B, Radio Network Controller (RNC), evolved Node B (eNB), Base Station Controller (BSC), Base Transceiver Station (BTS), Base Station (BS), Transceiver Function (TF), Radio Router, Radio Transceiver, Basic Service Set (BSS), Extended Service Set (ESS), Radio Base Station (RBS), or some other terminology.

An access terminal (AT) may comprise, be implemented as, or known as a subscriber station, a subscriber unit, a mobile/wireless device, a mobile station (MS), a remote station, a remote terminal, a remote device or unit, a user terminal (UT), a user agent, a user device, user equipment (UE), a user station, a wireless device, a wireless communications device, a mobile subscriber station, a handset, a user agent, a mobile client, a client, or some other terminology. In some implementations, an access terminal may comprise a cellular telephone, a cordless telephone, a Session Initiation Protocol (SIP) phone, a wireless local loop (WLL) station, a personal digital assistant (PDA), a handheld device having wireless connection capability, a Station (STA), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a multimedia device, a video device, a digital audio player (e.g., MP3 player), a camera, a game console, a tablet, or any other similar functioning device), a global positioning system (GPS) device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

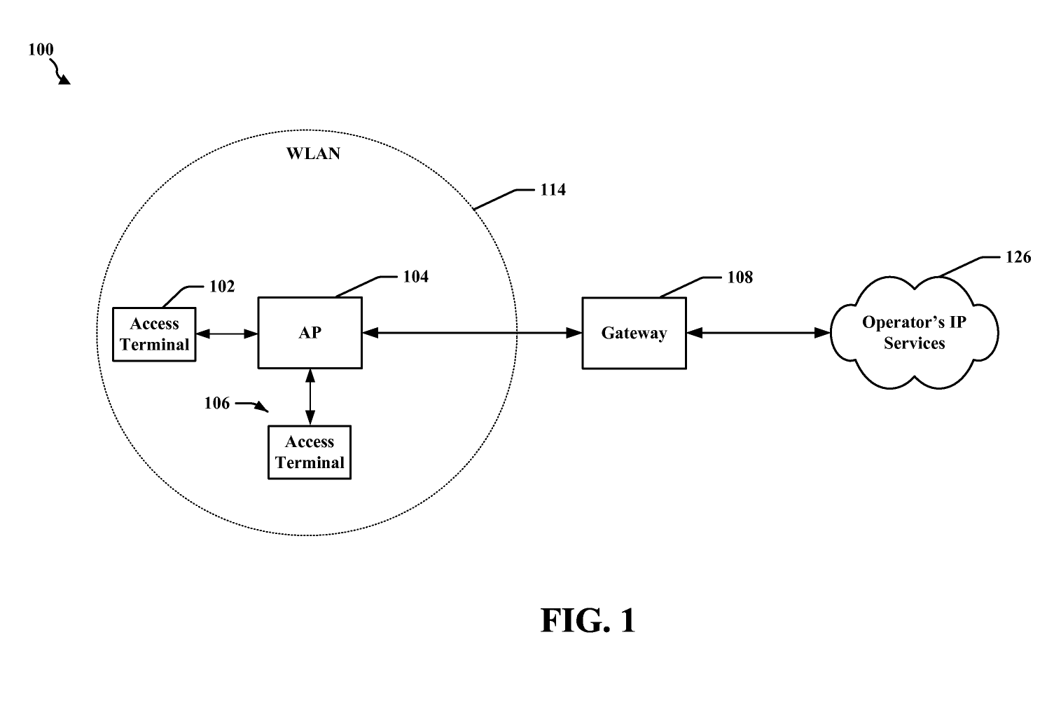

FIG. 1 is a diagram illustrating an architecture of a wireless network 100. The wireless network 100 may include one or more access terminals 108, one or more access points 104, which provide wireless communications in coverage area 114. An access point 104 may support WLAN services using one or more radio access technologies, wherein the services may include access to a wide area network, such as the Internet 126. An access point 104 may provide access to the Internet through a gateway 108. Gateway 108 may be assigned a subnet comprising a block of addresses, such as Internet Protocol (IP) addresses which may be assigned for use with one or more access terminals 102 and/or 106, access point 104 and/or other equipment in a WLAN.

An access point 104 may communicate with access terminals 102 and 106 using the same or different radio access technologies. An access point 104 may be part of a wireless network 100 provided by a single operator, and access to the operator's IP Services 126 may be provided through the gateway 108.

As illustrated by the examples described herein, the wireless network 100 may provide packet-switched services; however, as those skilled in the art will readily appreciate, the various concepts presented throughout this disclosure may be extended to networks providing circuit-switched services. One or more of network entities 104, 106, and/or 108 may be connected through wireless or wired connections, which may be referred to as backhaul connections.

The modulation and multiple access scheme employed by the wireless network 100 may vary depending on the particular telecommunications standard being deployed and different modulation schemes may be used for uplink (UL) and downlink (DL) communication. According to certain aspects, OFDM is used on the downlink and SC-FDMA is used on the uplink to support both frequency division duplexing (FDD) and time division duplexing (TDD). As those skilled in the art will readily appreciate from the detailed description to follow, the various concepts presented herein may be readily extended to various telecommunication standards employing different modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

An access point 104 may have multiple antennas enabling the access point 104 to exploit the spatial domain to support spatial multiplexing, beamforming, and transmit diversity. Spatial multiplexing may be used to transmit different streams of data simultaneously on the same frequency. The data steams may be transmitted to a single access terminal 102 to increase the data rate or to multiple access terminals 102 and 106 to increase the overall system capacity. This may be achieved by spatially precoding each data stream (i.e., applying a scaling of an amplitude and a phase) and then transmitting each spatially precoded stream through multiple transmit antennas on the downlink. The spatially precoded data streams arrive at the access terminal 102 with different spatial signatures, which enables each access terminal 102 or 106 to recover the one or more data streams destined for that access terminal 102 or 106. On the uplink, each access terminal 102 may transmit a spatially precoded data stream, which enables the access point 104 to identify the source of each spatially precoded data stream.

Each link pair may use multiple traffic classes in both uplink and downlink directions to achieve the application goals. The access point 104 typically experiences a heavy traffic burden because access point 104 can support multiple access terminals 102 and 106. Accordingly, certain embodiments employ a protocol that assigns the burden of media access contention to client access terminals 102 and 106. According to certain aspects of the protocol, each of the client access terminals 102 and 106 rely on uplink polling of access point 104 such that traffic through the access point 104 is never in contention for client access terminal 102 and 106 accesses. Contention may be allowed and/or limited to a first frame communicated between access terminal 102 and/or 106 access point 104 in order to allow multiple controllers to compete for a time slot of a super-frame structure, as timed by access terminal 102 and/or 106. Contention may then be disabled for other frames in the super-frame in order to create a “winner take all” effect for the time slot owner.

Certain advantages may be accrued from the use of the disclosed protocols. For example, power saving opportunities may be enhanced by reducing contention and eliminating certain signaling between each client access terminal 102 and/or 106 and a serving access point 104. In another example, each client access terminal 102 and/or 106 can control its own sleep schedule. A super-frame may define a period of time in which client access terminals 102 and 106 contend to perform at least one transaction. An access terminal 102 or 106 may migrate to a slot where the probability of contention with other controllers is significantly reduced and, having discovered such available slot, may establish the slot as the start of the super-frame, from its perspective. As used herein, the terms transaction and time slot (or slot) may relate to a period of time in which both client access terminal 102 and access point 104 exchange a set of frames. The set of frames may comprise a limited number of frames, which may include one frame per traffic class.

In certain embodiments, downlink and/or uplink data may be delivered in bursts of frames rather than in single frames during timeslots that are identified when the access terminal 102 is already awake. Certain embodiments, employ an unscheduled automatic power save delivery (U-APSD) scheme, in which one endpoint may perform polling to quickly obtain traffic queued by other endpoint. A network allocation vector (NAV) may be used to inform third-party nodes of a predicted transmission duration by one of two endpoints in a link.

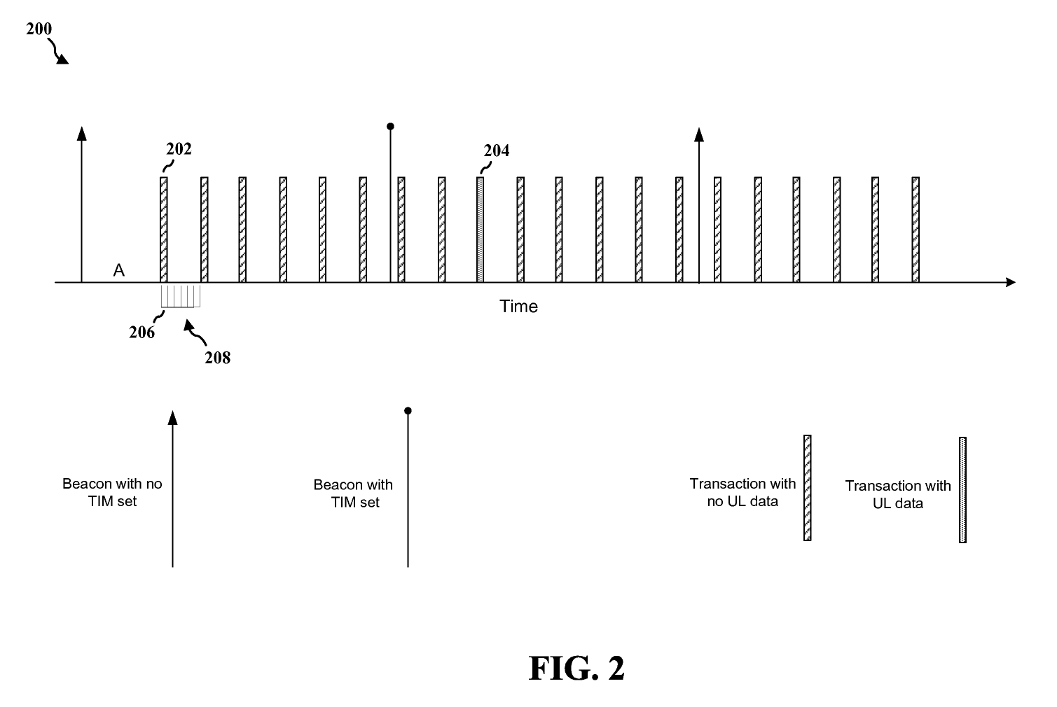

FIG. 2 is a timing diagram that illustrates a conventional mode of client communication with an access point. At point A, an access terminal 102, 106 associates with an access point 104. An access terminal performs association procedures to associate with an access point when the station is first powered up or moves into a new WLAN coverage area. Association refers to the mapping of an access terminal to an access point, which enables the access terminal to receive distribution service. The association allows the distribution service to know which access point to contact for the access terminal. The access terminal attempts to disassociate whenever it leaves the network. The access terminal performs reassociation procedures to move a current association from one access point to another access point. The association, disassociation, and reassociation procedures are described in IEEE802.11 standards.

After association, the access terminal 102, 106 initiates a number of uplink transactions 202, 204 with the access point 104. For the purpose of this description, each uplink transaction 202, 204 occupies and is coincident with a single slot 206 (referred to as a transaction slot, for clarity), although in some embodiments, a transaction 202, 204 may occupy a plurality of slots. Typically, an access terminal 102, 106 can engage in one transaction for each super-frame 208.

Each uplink transaction 202, 204 occurs within a transaction slot 206 of a super-frame 208. A super-frame 208 includes a number of adjacent slots and the transaction slot 206 in which the uplink transaction 202, 204 occur is typically a boundary slot, i.e., a slot either at the very beginning or the very end of the super-frame 208. After completion of a transaction 202 in a transaction slot 206, the access terminal 102 may hibernate or otherwise power-down until the next boundary slot in the next super-frame, when the access terminal 102 may awaken and transmit in a transaction slot 206 to initiate a second transaction with access point 104.

Uplink transactions 202, 204 may be divided into a plurality of types, including a trigger transaction 202 that includes no uplink data, and a data transaction 204 that does include data. Trigger transactions 202 ping the access point for data to be sent to the access terminal through a downlink transaction from the access point. Upon association of an access terminal 102, 106 with an access point 104 at point A, the access point continuously transmits trigger transactions 202 to the access point, regardless of whether the access point has data to download to the access terminal. This is highly inefficient with respect to power conservation.

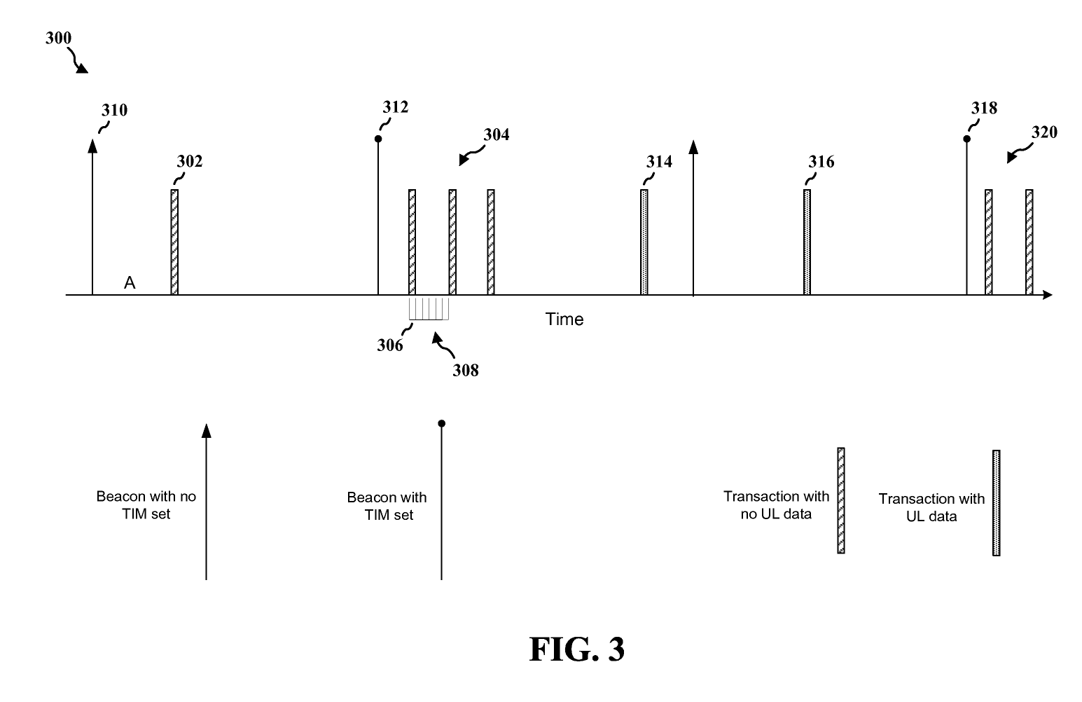

FIG. 3 is a timing diagram illustrating an enhanced mode of access terminal communication with an access point. In this mode, an access terminal 102, 106 receives a beacon signal 310 from an access point 104 and associates with the access point at point A. The access terminal 102, 106 then transmits a first transaction 302 to indicate a transition to sleep.

The access point periodically transmits beacon signals 310, 312, 318, for example, every 100 milliseconds. A beacon includes a traffic indication message (TIM) bit corresponding to an access terminal. When the TIM bit is set, it indicates to the access terminal 102, 106 that the access point 104 has data for the access terminal. In this case, the access terminal awakes from sleep. When the TIM bit is not set, it indicates to the access terminal 102, 106 that the access point 104 does not have any data for the access terminal. In this case, the access terminal remains in sleep mode.

In response to a beacon 312, 318 with TIM set, the access terminal 102, 106 awakes and transmits a burst of uplink trigger transactions 304, 320 until an indication is received from the access point 104 indicating all data intended for the access terminal 102, 106 has been pulled from the access point. Such indication is referred to herein as an empty indication and may be in the form of a null data packet (NDP). Each of the trigger transactions 304 is transmitted in a boundary slot 306 of a super-frame 308, over a series of super-frames. Once the empty indication is received, the access terminal 102, 106 then enters a sleep mode.

When the access terminal 102, 106 has data for the access point 104, the access terminal awakes from sleep mode and transmits the data in an uplink data transaction 314, 316 to the access point. Although not apparent from FIG. 3, the duration of a super-frame 308 may be extend to be integral multiple of slot times based on traffic classes and latency requirement of downlink traffic.

The enhanced mode of access terminal communication with an access point, as described with respect to FIG. 3, is advantageous over the conventional mode of FIG. 2. The enhanced mode transmits trigger transactions when it is aware that the access point has data for it. This is more power efficient over the conventional mode, in which the access terminal continuously pings the access point for data.

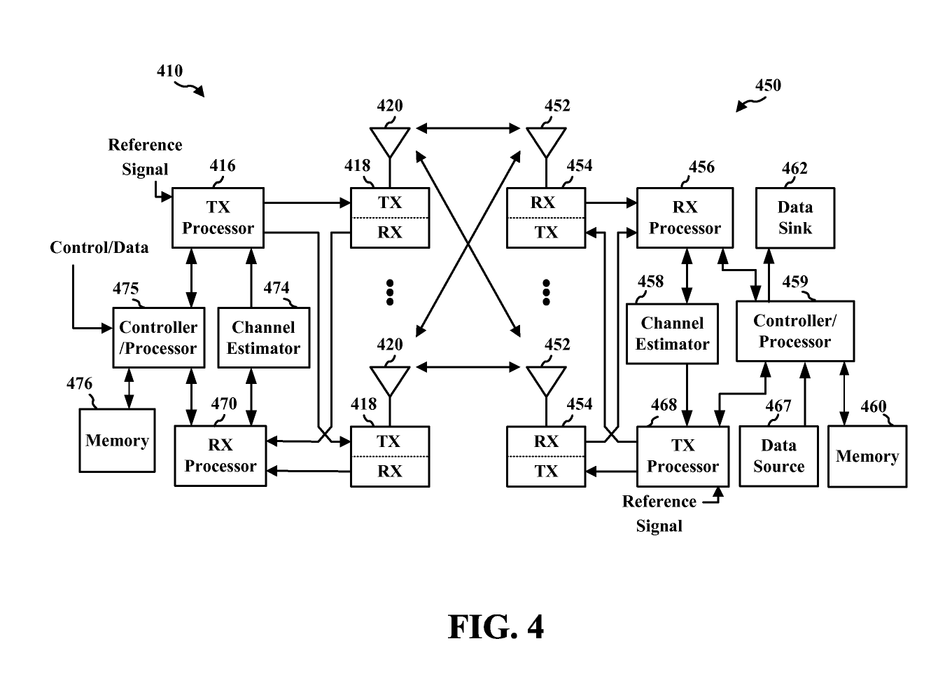

FIG. 4 is a block diagram illustrating an access point 410 in communication with an access terminal 450 in an example access network. In the downlink, packets from a core network are provided to a controller/processor 475. The controller/processor 475 implements various functionalities including, for example, header compression, ciphering, packet segmentation and reordering, multiplexing between logical and transport channels, and radio resource allocations to the access terminal 450 based on various priority metrics. The controller/processor 475 may also be responsible for retransmission of lost packets, and signaling to the access terminal 450.

Transmit (TX) processor 416 may implement various signal processing functions for the physical layer. The signal processing functions may include coding and interleaving to facilitate forward error correction (FEC) at the access terminal 450 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). In one example, the coded and modulated symbols are split into parallel streams, and each stream may be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream may be spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the access terminal 450. Each spatial stream may then be provided to a different antenna 420 via a separate transmitter 418TX. Each transmitter 418TX modulates an RF carrier with a respective spatial stream for transmission.

At the access terminal 450, one or more receivers 454RX receive a signal through respective antennae 452. Each receiver 454RX may recover information modulated onto an RF carrier and may provide the information to the receive (RX) processor 456. The RX processor 456 typically implements various signal processing functions of the physical layer. For example, the RX processor 456 may perform spatial processing on the information to recover any spatial streams destined for the access terminal 450. If multiple spatial streams are destined for the access terminal 450, they may be combined by the RX processor 456 into a single OFDM symbol stream. The RX processor 456 then may convert the OFDM symbol stream from the time-domain to the frequency domain using a Fast Fourier Transform (FFT). The frequency domain signal may comprise a separate OFDM symbol stream for each subcarrier of the OFDM signal. The symbols on each subcarrier, and the reference signal, may be recovered and demodulated by determining the most likely signal constellation points transmitted by the access point 410. These soft decisions may be based on channel estimates computed by the channel estimator 458. The soft decisions are then decoded and deinterleaved to recover the data and control signals that were originally transmitted by the access point 410 on the physical channel. The data and control signals are then provided to the controller/processor 459.

The controller/processor 459 can be associated with a memory 460, which may comprise non-transitory storage that stores program codes and data. The memory 460 may be referred to as a computer-readable medium. In the uplink, the controller/processor 459 typically provides demultiplexing between transport and logical channels, packet reassembly, deciphering, header decompression, control signal processing to recover upper layer packets from the core network. Packets may then be provided to a data sink 462, which may include one or more applications, etc. Various control signals may also be provided to the data sink 462 for further processing. The controller/processor 459 may also be responsible for error detection using an acknowledgement (ACK) and/or negative acknowledgement (NACK) protocol to support HARQ operations.

In the uplink, a data source 467 may be used to provide packets to the controller/processor 459. The data source 467 may comprise various protocol layers, and may include applications. Similar to the functionality described in connection with the downlink transmission by the access point 410, the controller/processor 459 implements various functions and may provide header compression, ciphering, packet segmentation and reordering, and multiplexing between logical and transport channels based on radio resource allocations by the access point 410. The controller/processor 459 may also be responsible for retransmission of lost packets, and signaling to the access point 410.

Channel estimates derived by a channel estimator 458 from a reference signal or feedback transmitted by the access point 410 may be used by the TX processor 468 to select the appropriate coding and modulation schemes, and to facilitate spatial processing. The spatial streams generated by the TX processor 468 are provided to different antenna 452 via separate transmitters 454TX. Each transmitter 454TX may modulate an RF carrier with a respective spatial stream for transmission.

The uplink transmission is processed at the access point 410 in a manner similar to that described in connection with the receiver function at the access terminal 450. Each receiver 418RX receives a signal through its respective antenna 420. Each receiver 418RX recovers information modulated onto an RF carrier and provides the information to a RX processor 470. The RX processor 470 may implement the physical layer.

The controller/processor 475 can be associated with a memory 476 that stores program codes and data. The memory 476 may comprise non-transitory storage that may be referred to as a computer-readable medium. In the uplink, the control/processor 475 provides demultiplexing between transport and logical channels, packet reassembly, deciphering, header decompression, control signal processing to recover upper layer packets from the access terminal 450. Packets from the controller/processor 475 may be provided to the core network. The controller/processor 475 is also responsible for error detection using an ACK and/or NACK protocol, for example.

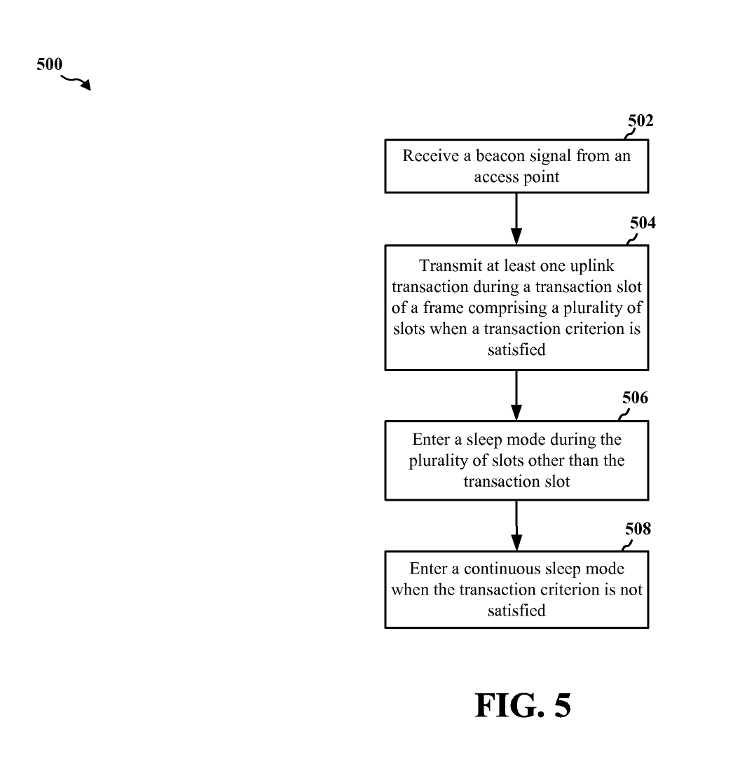

FIG. 5 is a flow chart 500 of a method of wireless communication. The method may be performed by an access terminal 102, 106. At 502, the access terminal 102, 106 receives a beacon signal from an access point. The beacon signal may include a component, such as a TIM bit, which when set serves as an indication that the access point has downlink data available for the access terminal.

At 504, the access terminal 102, 106 transmits at least one uplink transaction during a transaction slot of a frame including a plurality of slots, when a transaction criterion is satisfied. The transaction criterion may be satisfied upon receipt of a beacon signal indicating the access point has downlink data for the access terminal. In this case, the uplink transaction from the access terminal 102, 106 includes a trigger configured to pull downlink data from the access point. The access terminal 102, 106 may transmit a burst of uplink transactions over a number of frames, until it pulls all available downlink data from the access point and receives an empty indication from the access point indicating that all available downlink data has been pulled from the access point. The access terminal 102, 106 may adjust the duration of one or more of the number of frames based on a class of the downlink data, or a latency requirement of the downlink data.

The transaction criterion may also be satisfied when the access terminal determines a presence of uplink data at the access terminal that is intended for the access point. In this case, the access terminal 102, 106 transmits data to the access point during the uplink transaction.

At 506, the access terminal 102, 106 enters a sleep mode during the plurality of slots other than the transaction slot. At 508, the access terminal 102, 106 enters a continuous sleep mode when the transaction criterion is not satisfied. Thus, the present method provide an access terminal that awakes from sleep and actively polls an access point for data upon receipt of a beacon signal that includes an indication of available data. The access terminal pulls data from the access point until it receives an indication from the access point that no more data is available, at which time the access terminal goes to sleep. The access terminal also may awake to transmit uplink data.

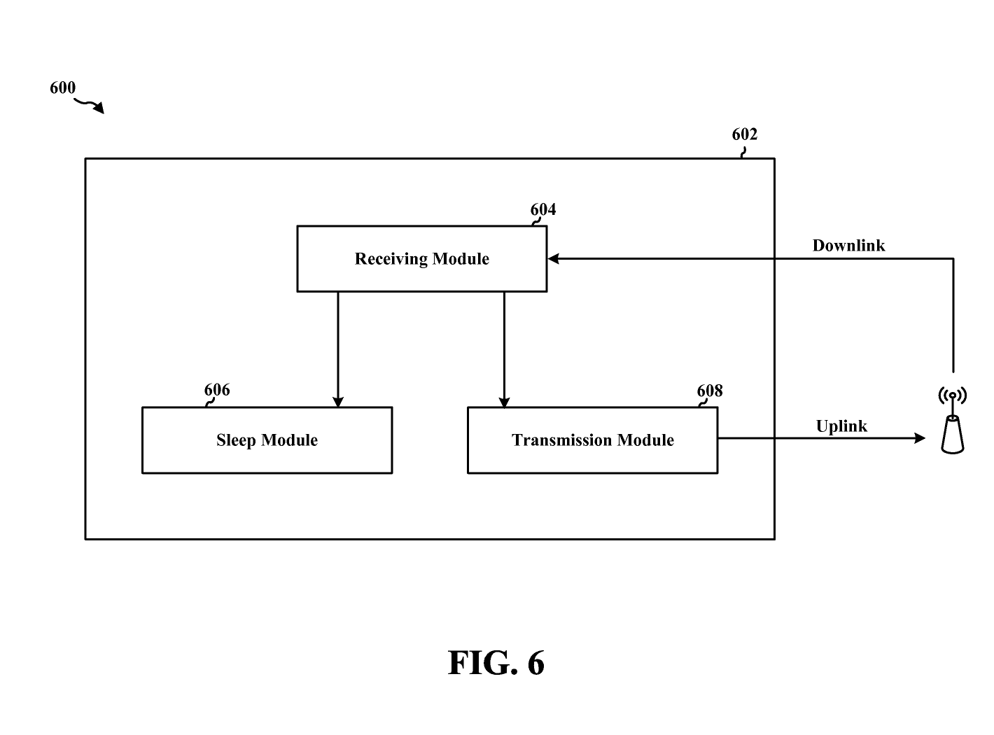

FIG. 6 is a conceptual data flow diagram 600 illustrating the data flow between different modules/means/components in an exemplary apparatus 602. The apparatus may be an access terminal 102, 106. The apparatus 602 includes a receiving module 604 that receives a beacon signal from an access point, a transmission module 606 that transmits at least one uplink transaction during a transaction slot of a frame comprising a plurality of slots when a transaction criterion is satisfied, and a sleep module 608 that enters a sleep mode during the plurality of slots other than the transaction slot, and enter a continuous sleep mode when the transaction criterion is not satisfied.

The apparatus may include additional modules that perform each of the steps of the algorithm in the aforementioned flow chart of FIG. 5. As such, each step in the aforementioned flow chart of FIG. 5 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

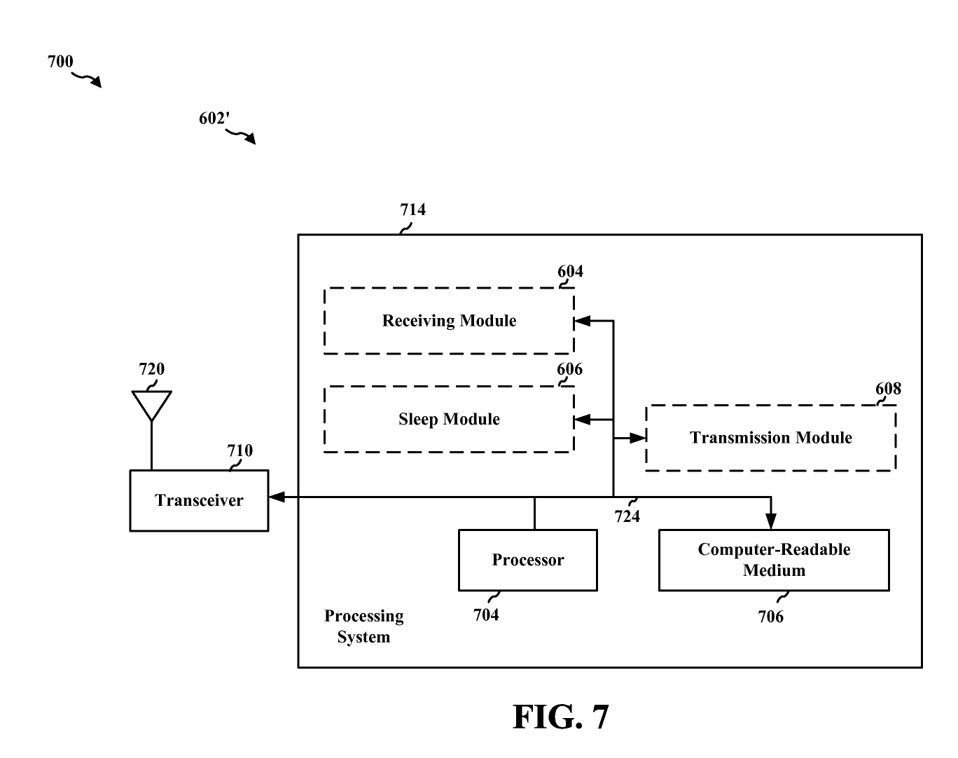

FIG. 7 is a diagram 700 illustrating an example of a hardware implementation for an apparatus 602′ employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 704, the modules 604, 606, 608 and the computer-readable medium 706. The bus 724 may also link various other circuits such as timing sources, peripherals, voltage regulators, and power management circuits, which are well known in the art, and therefore, will not be described any further.

The processing system 714 may be coupled to a transceiver 710. The transceiver 710 is coupled to one or more antennas 720. The transceiver 710 provides a means for communicating with various other apparatus over a transmission medium. The processing system 714 includes a processor 704 coupled to a computer-readable medium 706. The processor 704 is responsible for general processing, including the execution of software stored on the computer-readable medium 706. The software, when executed by the processor 704, causes the processing system 714 to perform the various functions described supra for any particular apparatus. The computer-readable medium 706 may also be used for storing data that is manipulated by the processor 704 when executing software. The processing system further includes at least one of the modules 604, 606, 608. The modules may be software modules running in the processor 704, resident/stored in the computer readable medium 706, one or more hardware modules coupled to the processor 704, or some combination thereof. The processing system 714 may be a component of the UE 450 and may include the memory 460 and/or at least one of the TX processor 468, the RX processor 456, and the controller/processor 459.

In one configuration, the apparatus 602/602′ for wireless communication includes means 604 for receiving a beacon signal from an access point, means 606 for transmitting at least one uplink transaction during a transaction slot of a frame comprising a plurality of slots when a transaction criterion is satisfied, means 608 for entering a sleep mode during the plurality of slots other than the transaction slot; and means 608 for entering a continuous sleep mode when the transaction criterion is not satisfied.

The aforementioned means may be one or more of the aforementioned modules of the apparatus 602 and/or the processing system 714 of the apparatus 602′ configured to perform the functions recited by the aforementioned means. As described supra, the processing system 714 may include the TX Processor 468, the RX Processor 456, and the controller/processor 459. As such, in one configuration, the aforementioned means may be the TX Processor 468, the RX Processor 456, and the controller/processor 459 configured to perform the functions recited by the aforementioned means.

The various aspects of a mobile device receiver described thus far may be integrated into a variety of devices, including by way of example, a wireless device. A wireless device may include various components that perform functions based on signals (e.g., comprising information such as data) that are transmitted by or received at the wireless device. For example, a wireless headset may include a transducer configured to provide an audio output to a user. A wireless watch may include a user interface configured to provide an indication to a user. A wireless sensing device may include a sensor configured to provide an audio output to a user or configured to provide audio to be transmitted via the transmitter.

A wireless device may communicate via one or more wireless communication links that are based on or otherwise support any suitable wireless communication technology. For example, according to certain aspects a wireless device may associate with a network. According to certain aspects the network may comprise a personal area network (e.g., supporting a wireless coverage area on the order of 30 meters) or a body area network (e.g., supporting a wireless coverage area on the order of 10 meters) implemented using ultra-wideband technology or some other suitable technology. According to certain aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components that may include various components (e.g., signal generators and signal processors) that facilitate communication over a wireless medium.

According to certain aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

The components described herein may be implemented in a variety of ways. For example, an apparatus may be represented as a series of interrelated functional blocks that may represent functions implemented by, for example, one or more integrated circuits (e.g., an ASIC) or may be implemented in some other manner as taught herein. As discussed herein, an integrated circuit may include a processor, software, other components, or some combination thereof. Such an apparatus may include one or more modules that may perform one or more of the functions described above with regard to various figures.

As noted above, according to certain aspects these components may be implemented via appropriate processor components. These processor components may be implemented, at least in part, using structure as taught herein. According to certain aspects a processor may be adapted to implement a portion or all of the functionality of one or more of these components.

As noted above, an apparatus may comprise one or more integrated circuits. For example, a single integrated circuit may implement the functionality of one or more of the illustrated components, while in other aspects more than one integrated circuit may implement the functionality of one or more of the illustrated components.

In addition, the components and functions described herein may be implemented using any suitable means. Such means also may be implemented, at least in part, using corresponding structure as taught herein. For example, the components described above may be implemented in an “ASIC” and also may correspond to similarly designated “means for” functionality. Thus, in some aspects one or more of such means may be implemented using one or more of processor components, integrated circuits, or other suitable structure as taught herein.

Also, it should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination thereof”.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (IC), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes (e.g., executable by at least one computer) relating to one or more of the aspects of the disclosure. In some aspects a computer program product may comprise packaging materials.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A method of wireless communication by an access terminal, comprising:
if a transaction criterion is satisfied:
transmitting at least one uplink transaction for an access point during a transaction slot of a frame comprising a plurality of slots, and
entering a sleep mode during the plurality of slots other than the transaction slot; and
if the transaction criterion is not satisfied, entering a continuous sleep mode.

2. The method of claim 1, further comprising receiving a beacon signal from an access point, wherein the transaction criterion comprises a presence of an indication in the beacon signal that the access point has downlink data available for the access terminal.

3. The method of claim 2, wherein the uplink transaction comprises a trigger configured to pull downlink data from the access point.

4. The method of claim 3, further comprising receiving an empty indication from the access point indicating that all available downlink data has been pulled, wherein a plurality of uplink transactions are transmitted over a plurality of frames, until the empty indication has been received.

5. The method of claim 4, further comprising adjusting the duration of at least one of the plurality of frames based on a class of the downlink data.

6. The method of claim 4, further comprising adjusting the duration of at least one of the plurality of frames based on a latency requirement of the downlink data.

7. The method of claim 1, wherein:
the transaction criterion comprises a presence of uplink data for the access point at the access terminal, and
the uplink transaction comprises a data transmission for the access point.

8. An access terminal, comprising:
means for transmitting at least one uplink transaction for an access point during a transaction slot of a frame comprising a plurality of slots, if a transaction criterion is satisfied;
means for entering a sleep mode during the plurality of slots other than the transaction slot, if the transaction criterion is satisfied; and
means for entering a continuous sleep mode, if the transaction criterion is not satisfied.

9. The access terminal of claim 8, further comprising means for receiving a beacon signal from an access point, wherein the transaction criterion comprises a presence of an indication in the beacon signal that the access point has downlink data available for the access terminal.

10. The access terminal of claim 9, wherein the uplink transaction comprises a trigger configured to pull downlink data from the access point.

11. The access terminal of claim 10, further comprising means for receiving an empty indication from the access point indicating that all available downlink data has been pulled, wherein a plurality of uplink transactions are transmitted over a plurality of frames, until the empty indication has been received.

12. The access terminal of claim 11, further comprising means for adjusting the duration of at least one of the plurality of frames based on a class of the downlink data.

13. The access terminal of claim 11, further comprising means for adjusting the duration of at least one of the plurality of frames based on a latency requirement of the downlink data.

14. The access terminal of claim 8, wherein:
the transaction criterion comprises a presence of uplink data for the access point at the access terminal, and
the uplink transaction comprises a data transmission for the access point.

15. An access terminal, comprising:
a transmitter to transmit at least one uplink transaction for an access point during a transaction slot of a frame comprising a plurality of slots, if a transaction criterion is satisfied; and
a processor coupled to the transmitter to place the access terminal into a sleep mode during the plurality of slots other than the transaction slot, wherein the processor to place the access terminal into a continuous sleep mode if the transaction criterion is not satisfied.

16. The access terminal of claim 15, further comprising:
a receiver to receive a beacon signal from an access point, wherein the transaction criterion comprises a presence of an indication in the beacon signal that the access point has downlink data available for the access terminal.

17. The access terminal of claim 16, wherein the uplink transaction comprises a trigger configured to pull downlink data from the access point.

18. The access terminal of claim 17, wherein:
the receiver is further to receive an empty indication from the access point indicating that all available downlink data has been pulled, and
the transmitter further to transmit a plurality of uplink transactions over a plurality of frames until the empty indication has been received.

19. The access terminal of claim 18, wherein the processor to adjust the duration of at least one of the plurality of frames based on a class of the downlink data.

20. The access terminal of claim 18, wherein the processor to adjust the duration of at least one of the plurality of frames based on a latency requirement of the downlink data.

21. The access terminal of claim 15, wherein:
the transaction criterion comprises a presence of uplink data for the access point at the access terminal, and
the uplink transaction comprises a data transmission for the access point.

22. A computer program product, comprising:
a computer-readable medium comprising code for:
if a transaction criterion is satisfied, transmitting at least one uplink transaction for an access point during a transaction slot of a frame comprising a plurality of slots, and entering a sleep mode during the plurality of slots other than the transaction slot; and
if the transaction criterion is not satisfied, entering a continuous sleep mode.

23. The product of claim 22, further comprising code for receiving a beacon signal from an access point, wherein the transaction criterion comprises a presence of an indication in the beacon signal that the access point has downlink data available for the access terminal.

24. The product of claim 23, wherein the uplink transaction comprises a trigger configured to pull downlink data from the access point.

25. The product of claim 24, further comprising code for receiving an empty indication from the access point indicating that all available downlink data has been pulled, wherein a plurality of uplink transactions are transmitted over a plurality of frames, until the empty indication has been received.

26. The product of claim 25, further comprising code for adjusting the duration of at least one of the plurality of frames based on a class of the downlink data.

27. The product of claim 25, further comprising code for adjusting the duration of at least one of the plurality of frames based on a latency requirement of the downlink data.

28. The product of claim 22, wherein:
the transaction criterion comprises a presence of uplink data for the access point at the access terminal, and
the uplink transaction comprises a data transmission for the access point.
